(19) United States
(12) Patent Application Publication
(10) Pub. No.: US 2013/0293811 A1
(43) Pub. Date: Nov. 7, 2013

(54) POLARIZATION SELECTIVE SCATTERING SECURITY DEVICE AND METHOD FOR MANUFACTURING THE SAME

(71) Applicant: Technische Universiteit Eindhoven, Eindhoven (NE)

(72) Inventors: Cees Bastiaansen, Montfort (NE); Thijs Meijer, Eindhoven (NE)

(21) Appl. No.: 13/937,291

(22) Filed: Jul. 9, 2013

Related U.S. Application Data
(63) Continuation of application No. 12/530,630, filed on Sep. 23, 2009, now abandoned.

(30) Foreign Application Priority Data
Mar. 13, 2007 (EP) 07005119.8
Mar. 13, 2007 (EP) 07005120.6
Mar. 13, 2007 (EP) 07005122.2
Mar. 13, 2007 (EP) 07005126.3

(51) Int. Cl. G02F 1/13

(52) U.S. Cl. CPC G02F 1/1313
USPC 349/86; 349/92

(57) ABSTRACT

A polarization selective scattering security device comprising a printed patterned birefringent matrix of LCP polymer comprising a dispersed phase and optionally one or more additives, wherein the ordinary or the extra-ordinary refractive index of the birefringent matrix of LCP polymer is approximately matched by one of the indices of refraction of the dispersed phase aligned in the same direction whereas the other refractive index is not matched. Moreover, a process for producing such security device is disclosed.

### RELATED APPLICATION

This application is a continuation of co-pending application Ser. No. 12/530,630 filed Sep. 23, 2009.

### DESCRIPTION

The present invention pertains to a polarization selective scattering security device and a process for manufacturing the same.

In order to prevent counterfeiting, there is a continuing need to secure valuable documents and products. Adding authentication features, which are very difficult to forge but typically easy to inspect, to these products helps against counterfeiting. Polymerizable Liquid Crystals (LCP's) are a class of materials which exhibit one or more liquid crystalline phases, such as a nematic, smectic or chiral nematic phase, within a certain temperature range. Furthermore, LCP's can be polymerized due to reactive groups which are part of the molecule. Before polymerization, LCP's are monomers, but also after polymerization the resulting polymers are commonly referred to as LCP's. In the text, where LCP's are mentioned the monomer form is referred to; the polymer form is referred to as LCP polymer. Moreover, the skilled person is able to differentiate between the polymeric and monomeric LCP's in the context of the specification and by using his common knowledge. Polymerization of LCP's can be induced spontaneously at elevated temperatures or aided by means of suitable initiators, such as for instance photo-initiators or thermal initiators. Common examples of reactive groups are acrylates, methacrylates, epoxies, oxethanes, vinyl-ethers, styrenes and thiol-enes. Here, monomers which by means of reactive end groups have the ability to form links with two other molecules are called mono-functional, since two links are the minimum number required to form a polymer. Monomers with the ability to form links with more than two other molecules are called higher functional.

Liquid crystals can exhibit anisotropic bulk properties due to the anisotropic molecular shape in combination with the inherent order in the liquid crystalline state. Among these anisotropic properties can be a difference in refractive index, which is known as birefringence. In the nematic phase, liquid crystalline molecules are locally aligned in the direction of the so-called director, the index of refraction along this director is the extraordinary index of refraction (nₑ) and that differs from the index of refraction in the directions perpendicular to the director, the ordinary index of refraction (nₒ). Other materials besides liquid crystals can exhibit birefringence, for instance stretched polymer films or crystalline minerals.

Liquid crystalline materials have various applications, more information on which can be found in many text books such as e.g. Optics of Liquid Crystal Displays (by P. Yeh and C. Gu, 1999, Wiley, New York), The Physics of Liquid Crystals (by P. G. de Gennes and J. Prost, 1995, Clarendon Press, Oxford).

A well known application is the liquid crystal display technology. FIG. 1 shows a schematic of a so-called twisted nematic liquid crystal cell. In a twisted nematic liquid crystal cell a layer of nematic liquid crystalline material is positioned in between two polarizers whose polarization directions are orthogonal. The alignment of the liquid crystalline material is induced by aligning surfaces and by electrical fields which can be applied.

In the OFF state, no electrical field is applied and the liquid crystalline material is oriented such that it acts as a waveguide, changing the polarization of light passing through the liquid crystalline material by 90 degrees so that the light passes through the second polarizer. The cell is then transparent. By applying a field in the ON state, the liquid crystalline material is oriented such that it does not change the polarization of passing light so that light cannot pass the second polarizer and therefore does not pass the cell. The cell is thus non-transparent.

Another application is the polymer dispersed liquid crystal (PDLC), as shown in FIG. 2. A PDLC consists of a layer of material consisting of a non-polymerized liquid crystalline phase, which is dispersed in a polymer matrix. The liquid crystalline material is anisotropic, meaning that it has two indices of refraction, nₑ and nₒ, for different polarization directions of light. The polymer matrix is isotropic, meaning that it has only one refractive index n. The liquid crystalline phase forms droplets with sizes in the order of magnitude of micrometers. When an electric field is applied, all the liquid crystalline droplets are aligned in the direction of the field. The indices of refraction of the liquid crystalline material and the polymer matrix are chosen such that the indices of refraction in plane of the PDLC match. In this case light passing through the material interacts with only one index of refraction. The light is therefore not scattered and the layer is transparent. When no electric field is applied to the PDLC, each droplet of liquid crystalline material is aligned differently. This means that the index of refraction in plane of the PDLC differs between the different droplets and the polymer matrix. This leads to scattering of light passing through the material and the layer is opaque.

Another application of liquid crystalline materials is cholesteric films. In FIG. 3 a schematic of a cholesteric layer is depicted. In the cholesteric phase the liquid crystalline molecules are all aligned in one direction in one plane (horizontal in the figure), but that direction of alignment rotates in the direction perpendicular to the plane as indicated in FIG. 3. The distance over which the direction of alignment rotates 360 degrees is called the pitch. The periodic change of the alignment causes a cholesteric film to act as a Bragg grating. The material reflects light if the wavelength λ is equal to λ=p*n*cos(theta), where p is the size of the pitch, n is the refractive index and theta is the angle between the direction of incident light and the normal to the surface of the cholesteric film. This means the reflected colour of these cholesteric films is angular dependent. It should be noted that only one handedness of circularly polarized light is reflected, depending on the handedness of the rotation of the alignment of the liquid crystalline material. This type of material is used both for optical application as well as for decorative or security applications.

In the prior art combinations of PDLC systems wherein the liquid crystalline material has a cholesteric phase are also known, e.g. in EP0803525A. In FIG. 4 a cholesteric PDLC is shown. If one considers a matrix which is cholesteric and a dispersed phase which is liquid crystalline and also cholesteric and co-aligning, the entire layer is uniformly cholesteric and therefore it is non-scattering. If an electric field is applied, the alignment of the liquid crystalline phase changes, the layer is not uniform and thus the PDLC is scattering.

FIG. 5 shows a schematic of the dependency of scattering on the polarization direction of light passing through a birefringent layer (the matrix) in which another phase is dispersed in regions with dimensions in the range of 0.1-10 μm. Both phases are at least partially transparent to electromagnetic waves in the UV, visible or IR part of the spectrum that pass through it. Combined into a single layer, such a system exhibits polarization dependent scattering if one of the refractive indices of the matrix has a good match with one of the refractive indices of the dispersed phase, and that these two indices affect the same polarization direction of the light passing through, and that the two indices affecting the other polarization direction are not well matched.

In case the ordinary index of refraction is matched, the overall layer
scatters part of the non-polarized light passing through the layer;
scatters all the light polarized parallel to the extraordinary index of refraction of the liquid crystal matrix and
is fully transparent to the light polarized parallel to the ordinary index of refraction of the liquid crystal matrix.

Scattering effects in layers are used in different areas of display technology. Scattering polarizer films can also be created by uniaxial stretching of phase separated polymer films as described in U.S. Pat. No. 5,876,316, by uniaxially stretching polymer dispersed liquid crystal films, as described by Aphonin et al. (Liquid Crystal, vol. 15, p. 395-407, published in 1993) or by uniaxially stretching isotropic particle dispersed polymer films as described by Dirix et al. (Journal of Applied Physics, vol. 83, no. 6, p. 2927-2933, published in 1998).

Such scattering polarizer films could be used as authentication features. However, such applications are based on films that require additional stretching to create the effect. Furthermore, as these production techniques can create films only, they are intrinsically less suited as a security feature, where patterned structures are preferred since these enhance recognition and can contain information. These patterned surfaces could either be the same each time, or more preferably unique each time, since this allows for serialization or personalization of the authentication features by having shapes with for instance unique codes, fingerprints and iris scans.

One objective of the present invention is to provide a polarization selective scattering security device that does not show the disadvantages of the prior art, and is easy to manufacture.

This objective can be achieved by providing a polarization selective scattering security device comprising a printed patterned birefringent matrix of LCP's in which a dispersed phase is created by means of phase separation. Subsequently the printed structure is polymerized. The phase separation takes place in the printed structure during and/or before polymerization of the structure. As a consequence the invention is directed to a polarization selective scattering security device comprising a printed patterned birefringent matrix of LCP polymer comprising a dispersed phase, wherein the ordinary or the extra-ordinary refractive index of the birefringent matrix of LCP polymer is approximately matched by one of the indices of refraction of the dispersed phase aligned in the same direction whereas the other refractive index is not matched.

The materials of both phases in the structure should be chosen such that the polarization sensitive scattering effect is achieved. This requires that the ordinary or the extra-ordinary refractive index of the birefringent LCP matrix is approximately matched by one of the indices of refraction of the dispersed phase aligned in the same direction whereas the other refractive index is not matched. This means that preferably Δn_{matching} is smaller than 0.05, more preferably Δn_{matching} is smaller than 0.01, and that preferably Δn_{not matching} is greater than 0.05, with the proviso that Δn_{matching} should always be smaller than Δn_{non matching}. The dispersed phase can therefore be birefringent, as long as only one of the two indices of refraction of the birefringent LCP matrix is matched by the equally aligned dispersed phase refractive index and the other is non-matched. In case the dispersed phase is non-birefringent, the overall index of refraction of this dispersed phase has to match one of the refractive indices of the LCP matrix. Since the refractive indices of the LCP matrix may change slightly during polymerization, care has to be taken to match the polymerized LCP matrix refractive indices, since polymerization is greatly desired in view of the creation of practical security features.

The advantage lies in the fact that the phase separation of material in a LCP matrix requires no additional steps to create the polarization sensitive scattering effect. This enables direct application, thus printing, of the feature.

The invention is also directed to a process for manufacturing the polarization selective scattering security device according to the invention, comprising the steps of printing a mixture comprising at least one LCP, comprising one or more functional groups as the first material and at least one second material comprising liquid crystalline or non-liquid crystalline molecules
letting the LCP's align on a substrate, characterized in that
significant fractions of the molecules of the second material are allowed to phase separate from the bulk to form regions with dimensions of 0.1 to 10 micron in diameter and that
during or after phase separation the aligned liquid crystal phase is polymerized to form a solid matrix.

Optionally, the second material, i.e. the phase separated regions can be polymerized as well, which has the benefit that the entire print is solid, thus lending superior mechanical properties to the structure as well as preventing possible rupturing of the phase separated regions which could cause the effect to be either diminished or lost as well as potential leaking of material from the print.

The materials constituting the birefringent LCP matrix as well as the dispersed phase are not necessarily mono-components; also mixtures of materials in both phases are possible.

The phase-separated or second material embedded in the matrix can either be polymerizable or non-polymerizable or partially polymerizable, depending on the specific mixture. It is preferred that the second material is non-liquid crystalline material, even more preferred a non-liquid crystalline polymerizable material. Preferably, the printed mixture contains a phase-separating fraction below 50% weight, very preferably below 30%, highly preferably below 15%.

It is also possible for the dispersed phase to be polymerized before addition to the mixture and thus before printing, if it is non-birefringent. This has several advantages. The dispersed phase can now be controlled in size more precisely without the need to control the phase separation in detail. This allows for less variation in size, in particular when using mono-disperse pre-polymerized structures, which are preferably spheres or sphere-like, but could also have other shapes such as rods, cones, pyramids, etc.

High control over the size and structure of the dispersed phase can give rise to another optical feature, namely Bragg scattering. E.g. if the dispersed phase consists of spheres packed in a well defined crystal structure it will show Bragg scattering of particular wavelengths dependent on the size of the crystal structure. Due to the birefringent matrix, these scattered wavelengths will be polarization dependent, thus having different transmission properties for different polarizations.

Furthermore, the time needed for phase separation to reach a suitable degree can be eliminated from the production process when using a dispersed phase polymerized before addition. Also, with such structures, it is easier to control the additives which are included or excluded from the dispersed phase, since with phase separation these additives might not migrate to either of the two phases completely. The various possible additives will be described below in more detail.

Printing of the mixture can be achieved by standard means, such as contact or non-contact printing. It is, however, preferred that the printing is being performed by ink-jet printing. If inkjet printing is chosen as the printing technique, this has the advantage that unique patterns (i.e. different for all prints) can be printed, which is especially useful for instance when a need exists to track and trace each individual document or product or to include specific information such as biometric information. Other examples of printing include but are not limited to offset printing, screen printing, flexography, contact printing, intaglio printing, gravure printing, roto-gravure printing, reel-to-reel printing, and thermal transfer printing.

The mixture to be applied can be in the form of a solution in a suitable solvent, or without any solvent. Solvents here are materials which cause the components of the mixture to dissolve in them and form a solution, with the exception of the optional pre-polymerized non-birefringent phase-separating material as well as particular additives such as pigments (described below), which should not dissolve in the solvent. Furthermore, such solvents here are intended to evaporate after processing but preferably before polymerization, so the solvent is not contained in any significant amount in the final print. Examples of commonly employed solvents for LCP's are xylene, toluene and acetone.

The printed mixture can contain surfactants. These surfactants can either enhance the alignment of the liquid crystalline matrix at the top of the structure, at the bottom or in the bulk or in combinations of those locations. Furthermore, these surfactants can influence phase separation of the mixture or influence the mechanical properties (e.g. viscosity, surface tension) of the mixture during printing and while on the substrate or can perform a combination of these three functions. The fraction of surfactants is preferably below 15 wt %, very preferably below 5 wt %, highly preferably below 2 wt %.

Other examples of additives are pigments and dyes. Pigments and dyes can be added to give the mixture an intrinsic color by means of absorption of part of the spectrum as well as optionally luminescence in part of the spectrum. Such intrinsic color can enhance the optical effects of the printed structure, for instance by enhancing contrast of (parts of) the printed structure.

Pigments are particles which do not dissolve molecularly whereas dyes can be approximately molecularly dissolved. The choice between pigments and dyes is dependent on various factors. One important factor is the solubility of the dyes or the pigments, with or without the aid of a dispersant, to create a stable ink. Solutions with dyes are generally easier to process than dispersions with pigments, but the optical properties of pigments are usually more stable. For pigments it is also clear that they can also act as the dispersed phase of the polarization dependent scatterer. And alternatively, a pre-polymerised dispersed phase which contains a dye of any kind, can be regarded as a pigment. Furthermore, certain optical additives are only available as pigments and not as dyes, such as di-electric stacks, whose optical effects are not based on molecular effects, but on effects on a larger scale. Another important factor is the price of pigments, which is usually higher than that of dyes.

In the case that pigments are at least partly transparent and approximately match only one of the refractive indices of the birefringent matrix, these pigments can also be used to create the scattering polarization effect. These pigments can also have different optical properties.

Examples of absorbing pigments or dyes are for instance
Absorbing only, meaning that a specific part of the spectrum is absorbed
Photochromic pigments or dyes, which by excitation with light of a particular part of the spectrum reversibly change into another chemical species having a different absorption spectrum from the original chemical species. Non-reversible photochromic pigments and dyes also exist for specific purposes
Thermochromic pigments or dyes, which exhibit a reversible change in absorption spectrum through the application of heat (i.e. at raised temperatures) Non-reversible thermochromic pigments and dyes also exist for specific purposes
Electrochromic pigments or dyes, which exhibit a change in absorption spectrum through the addition of electron charges
Ionochromic pigments or dyes, which exhibit a change in absorption spectrum through the addition of ionic charges.
Halochromic pigments or dyes, which exhibit a change in absorption spectrum through changes in pH.
Solvatochromic pigments or dyes which exhibit a change in absorption spectrum through changes in the polarity of the solvent which is in contact with them.
Tribochromic pigments or dyes, which exhibit a change in absorption spectrum as a result of friction applied to them.
Piezochromic pigments or dyes, which exhibit a change in absorption spectrum through changes in the pressure applied to them.

Examples of luminescent pigments or dyes are for instance
Fluorescent pigments or dyes, which exhibit absorption of light in a particular part of the spectrum and emission in another part of the spectrum, typically at a lower wavelength, where the absorption and emission of individual photons occur subsequently but with delays of typically nano-seconds.
Phosphorescent pigments or dyes exhibit similar absorption and emission as fluorescent dyes, but due to a different quantum mechanical decay mechanism typically emit photons after absorption with much larger delays of up to hours or days.
Chemoluminescent pigments or dyes, which exhibit emission of photons as a result of chemical reactions of the pigments and dyes. Such reactions are generally non-reversible.
Electroluminescent pigments or dyes, which exhibit emission of photons as a result of radiative recombinations of electrons and holes within the pigments or dyes. Such radiative recombination can occur if an electric current is passed through the pigments or dyes, or alternatively if they are subjected to strong electric field capable of exciting electron-hole pairs which subsequently recombine.
Triboluminescent pigments or dyes, which exhibit emission of photons as a result of friction applied to them.
Piezoluminescent pigments or dyes, which exhibit emission of photons as a result of pressure applied to them.
Radioluminescent pigments or dyes, which exhibit emission of photons as a result of ionizing radiation, such as beta particles, applied to them.

There are also pigments or dyes which combine multiple optical effects within a single additive, or which in fact is an effect which is related to multiple causes concurrently. Examples are
Thermochromic pigment capsules which change colour if heated above a certain threshold temperature. At this temperature the crystalline solvent in the capsule melts and effectively lowers the pH. This in turn causes the halochromic compound present to change its absorptive properties.
Photochromic fluorescent dyes are dyes which exhibit fluorescence only after the molecule has absorbed photons from a part of the spectrum which it does not absorb in its subsequent fluorescent state. This effect which is concurrently photochromic and fluorescent, i.e. due to the first absorption not only the absorptive properties of the molecule changes (photochromism) but also the molecule subsequently exhibits fluorescence or a change in its fluorescent properties.

Pigments and dyes can exhibit anisotropic optical properties, depending on their molecular orientation. If anisotropic dye molecules align to a significant degree within the LCP matrix, typically parallel or perpendicular to the LCP alignment, typically caused by a distinct anisotropic molecular shape, these molecules can exhibit their anisotropic optical properties collectively, leading to distinctive optical effects, which remain after polymerization of the LCP matrix. This effect is commonly known as dichroism or pleochroism. Pigments can also exhibit dichroic effects if the particles as such have anisotropic optical properties. However, such properties are difficult to exploit since for a collective effect all pigments have to be effectively aligned in the direction of their inherent anisotropy.

It is possible to create features which exhibit fluorescent dichroism in absorption but not in emission or vice versa. This effect can be achieved for instance by using two fluorescent molecular species, one of which absorbs and emits essentially non-dichroic and the other essentially dichroic. By choosing both species in such a way that the absorbed photon-energy is transferred to the other species, such effects can be obtained. Also, fluorescent molecules can exhibit different degrees of dichroism in absorption and emission, but the effect with using multiple suitably chosen species is in general more pronounced.

Especially when an aligning dichroic dye is mixed into the liquid crystalline matrix, this can give rise to specific optical effects. Particular embodiments are the situations when a dichroically emitting fluorescent dye is aligned in the liquid crystalline matrix, such that the axis of emission is equal to the axis in which the refractive indices of the matrix and dispersed phase are not matched. Direct optical inspection of this system under UV-light will reveal a fluorescent partially scattering system. When viewing through a polar under UV-light the system is transparent and non-fluorescent for one polarization direction, and fluorescent and scattering in the other polarization direction.

Another particular embodiment is a system where a dichroically absorbing dye is aligned in the liquid crystalline matrix, with the axes of absorption parallel to the direction in which the refractive indices of the matrix and dispersed phase are matched. If this feature is inspected under linearly polarized UV-light, it will be transparent and fluorescent when the polarization direction of the UV-light is parallel to the absorption axis of the dye. The feature is scattering and non-fluorescent when the polarization direction of the UV-light is orthogonal to the absorption axis of the dye.

Combinations of anisotropic dyes or pigments in the matrix or in the dispersed phase can give rise to many more optical effects.

UV-absorbing pigments and dyes or pigments can serve several specific purposes. Such UV-protecting pigments and dyes can be present in the printed mixture or applied over the printed structure after curing by another printing step, preferably by means of flexography or offset printing. Also other application methods can be employed, such as bar-coating, doctor blading, spraying or by applying a UV-absorbing substrate on top of the printed substrate.

As these pigments or dyes absorb UV light, they can protect the printed layer, or the substance underneath this layer, from harmful UV-radiation which can lead to degradation of the (mechanical) properties of the structures, such as brittling. During the UV-curing of the printed layer, UV-absorbers can also be used to prevent the deeper parts of the layer of being polymerized, thus allowing for a non-polymerized layer to exist, whereas the top layer is solidified during polymerization. Also, such a non-polymerized layer is not created but there is formed a gradient in the structure if specific components of the mixture diffuse towards or away from the higher polymerized regions during polymerization. Such gradients create new optical effects. For instance, a gradient in the amount of chiral dopant leads to structures after polymerization which exhibit a gradient in the chiral pitch, thus reflecting light over a greater wavelength range than a single pitched structure would. This effect is known as a broadband cholesteric mirror.

Other examples of additives are conductive or semi-conductive additives. Such additives can for example consist of the following group of additives:
nanometer or micrometer sized rods, flakes, spheres or otherwise suitably shaped conductive particles of metals, alloys or semiconductor-based materials made from for example (metals) iron, aluminium or copper or (semiconductors) GaAs, doped silicon or graphite.
semi-conductive conjugated polymers, such as polyphenylene vinylene
semi-conductive liquid crystalline molecules, such as oligothiophenes, which are preferably LCP's.

Such conductive additives enable the printing of electronic circuits. Such circuits can be used for instance to create optical effects which are switchable by means of electrical signals. The conducting properties of the structure itself too can be used as an authentication feature. This can be done particularly effectively if elements of electronic circuits, such as FET's, diodes or capacitors are created within the print, since these give rise to designable and clearly identifiable electronic responses. It is possible that the conductive structures are used to make switchable another, adjacent non-conductive printed structure, either of which is not necessarily but preferably applied by means of inkjet printing. Such multi-layered prints are advantageously created sequentially or concurrently, either in a single layer or in separate layers, printed either on top of or next to each other or even on opposite sides of the substrates or on multiple substrates which are assembled together after printing. Furthermore, it is possible to create structures which are conductive and contain electroluminescent or electrochromic additives, which can be addressed (made to change the optical appearance of the feature) by currents flowing through the printed structure itself. Furthermore, by supplying charges of equal or opposite sign to two electrically isolated by adjacent parts of the structure, capacitators can be formed. If such parts of the structure are able to move mechanically, such movement can give rise to e.g. altered optical, mechanical, electrical or magnetic properties of the printed structure, which can be used to authenticate the feature.

It is particularly beneficial that the printed structures are (in part) made from LCP's, since the anisotropic properties of the aligned LCP polymer matrix can enhance the electrical and mechanical properties desired to fully exploit the conductive properties of the print.

Other examples of additives are magnetic additives, such as paramagnetic, super-paramagnetic, diamagnetic or ferri-magnetic particles. Such particles are typically 5 to 500 nm in size. The addition of such particles enables the creation of structures that can be moved mechanically by means of magnetic fields. Again, such movement can give rise to e.g. altered optical, mechanical, electrical or magnetic properties of the printed structure, which can be used to authenticate the feature.

A particular benefit of adding (semi-) conductive or magnetic additives to the prints is that the authentication is straightforward by means of electric and magnetic fields or currents, and the effects can be reversible enabling non-destructive authentication. Furthermore, a particular benefit of inkjet printing such structures is that these additives can be printed in varying structures, thus enabling unique and identifiable responses to electrical or magnetic fields.

It is particularly beneficial that the printed structures are (in part) made from LCP's, since the anisotropic properties of the aligned LCP polymer matrix can enhance the electrical and mechanical properties desired to fully exploit the magnetic properties of the print.

The magnetic particles can also be embedded within a polymer bead, thus creating beads that can act as a dispersed phase but also are magnetic.

During phase separation, the additives can remain in the bulk or migrate to the phase separated regions, or be present in both in varying weight ratios, depending on the specific mixture and phase separating conditions such as the total time that is allowed for phase separation before full polymerization. It is also possible to include several additives which may be distributed over the two phases in varying ways, in order to achieve distinct optical properties. If the phase separated regions are pre-polymerized prior to printing as described above, no redistribution of additives into or out of the dispersed phase is possible. This has the specific advantage that additives present either in the LCP matrix or in the phase separated regions are only present where intended beforehand and remain there during polymerization, thus facilitating designs which would not be enabled if the additive(s) of choice did not phase separate completely.

One skilled in the art will with this description be able to create new effects achievable by phase separation by employing multiple additives or additives with other optical properties or other additives with other physical or chemical properties.

When using a non-reactive LC-containing dispersed phase, these LC molecules could be manipulated by means of electric or magnetic fields. By applying such fields the refractive indices of the non-reactive LC dispersed phase can be adjusted to match or mismatch the indices of the LCP polymer matrix, thereby changing the optical properties of the printed structure and optionally enhance, change or decrease the polarizing scattering effect. The inclusion of additives, in particular optical additives, can enhance these already distinct switching effects even further.

The printing takes place preferably on a planar aligning substrate, which is furthermore preferably transparent and preferably flexible. Such an aligning substrate induces the planar alignment of the LCP's which causes homogenous birefringence of the LCP matrix before and after polymerization. Commonly used planar aligning substrates are rubbed polyimide, as well as rubbed tri-acetyl-cellulose, polyethylene terephthalate, polyethylene or polypropylene. Rubbing causes planar aligning properties for these substrates. Other less preferred alignment techniques could also be employed, such as by means of electric or magnetic fields, flow alignment or alignment by means of polarized light.

Other substrates, also substrates causing other types of homogenous alignment, are known in the art as well. Common types of alignment are e.g. planar, homeotropic and tilted alignment.

LPP (Linearly Photopolymerizable Polymers) layers can also be used as alignment layers. LPP allows for the patterning of the alignment layer by means of polarized light and thus multi-domain patterning of the alignment layer. Furthermore it is possible to use self-assembled mono-layers (SAM's) as alignment layers, which can easily be applied in a pattern by e.g. printing. Combinations of for instance SAM's and LPP or TAC layers allow for an increased control over the alignment of the LCP's in the azimuthal and polar direction.

The combination of polarization selective scatterers on patterned alignment layer gives the option to include hidden information into layers of the polarization selective scatterer. A particular embodiment is a polarization selective scatterer printed in a flat continuous layer on top of a patterned LPP layer. The LPP layer should be locally aligning in one direction, whereas on other areas the alignment should be orthogonal. The polarization selective scatterer is than partially scattering when viewed upon directly. When the system is viewed through polarizer the LPP pattern is revealed: where the system is aligned so that the refractive indices match in the direction of the polarizer it is transparent, in the other areas it is scattering. When the polarizer is rotated over 90 degrees, the transparent and scattering areas are inverted.

Next to the aligning properties of the surfaces, the choice in substrates also determines the interactions between the mixture and the substrate. These interactions can be used to create additional (optical) effects. E.g. the use of hydrophobic of hydrophilic (chemically) patterned surfaces allows for print confinement and thus a higher print resolution and more striking optical effects. A geometrically patterned surface can also be used to confine printed ink. Confinement can lead to printed structures with more controlled geometries, leading to better defined properties which are beneficial for authentication purposes. Such chemical or geometrical patterning of the substrates can be achieved by means of printing, but also other techniques such as for instance embossing, rubbing and lithography.

The optical properties of the employed substrates influence the overall properties of the security feature. Such substrates can be combined, i.e. stacked on top of each other creating a multi-layered security feature, or a security feature created on a stack of substrates each having particularly beneficial properties. Dependent on the preferred optical effects, the substrates can be transparent, absorbing in any range of wavelengths, scattering or reflecting or can comprise patterns of these effects. The substrates can also have other optical properties. Examples are the ability to transmit only one polarization, as is the case with polarization films which transmit only one linear polarization, or the ability to reflect only one polarization, e.g. cholesteric films only reflect one handedness of light. Furthermore the substrates can change the polarization of transmitted or reflected light, as is the case with for instance retarder films and half wave plates.

The substrates can also contain other authentication features. Examples are holograms, retro-reflecting layers, interference stack reflectors, fluorescent layers, color-shifting layers or features printed by means of flakes. It is also possible to add layers containing other authentication features on top of the LCP polymer structures, via e.g. lamination.

It is preferred that the as-produced features are created such that they can be applied as tamper evident labels to products or documents. Such labels have properties which render the intact removal of the labels very difficult. Such properties could be poor mechanical integrity, for instance features which have low toughness, i.e. low resistance to tearing. Furthermore, the features upon removal can leave behind clear traces of its previous presence, for instance by means of rupture-sensitive ink particles.

It is also preferred that the features can easily be applied to the documents and products. Such application can for instance be by means of hot-embossing or by creating self-adhesive features.

The device produced in the manner as described above can be used to authenticate products or documents. In practice, an observer would see a printed marking which consists of the printed structure, which is under normal lighting conditions opaque or semi-opaque due to the scattering effect and partially or completely covers any information that is already present underneath the scattering feature. Therefore, the aligning substrate should preferably be transparent to achieve this effect. This information can be present in the form of a patterned absorbing, reflecting or diffracting structure. Such information could be a serial code, a password, a photograph, biometric information, a logo or schematic, or such. The observer then reveals the underlying information by holding a polar filter in front of the feature and aligning its polarization axis with the LCP polymer matrix axis which is index-matched with the dispersed phase. The feature will then be transparent to the observer. As an additional check, the observer may then turn the axis of the polar filter by 90 degrees to further render the layer opaque to the observer. This second check will be particularly striking if the layer is semi-opaque when observed in non-polarized light. As the scattering layer can be printed in a pattern, the pattern itself too can contain information. The polarization selective scattering security device is new and unknown, which is an important feature in the security industry. It has a distinctly different appearance when compared to other security features such as holograms or color shifting inks. It has an easy verification by a single polar, which allows for easy visual recognition. Furthermore, fast automated verification of said markings, where the automated procedure would typically include at least one optical check, although more elaborate procedures could be implemented to further, enhance the level of confidence in the authenticity of the feature.

The invention will be further elucidated with the following non-limitative examples.

### EXAMPLE 1

A mixture is prepared by adding components 1 through 5 consecutively and magnetically stirring it at 60° C. for 15 minutes to obtain a clear solution, where the components are
1) 3.9 wt % non-reactive liquid crystal mixture E7 (Merck KGaA, Germany) consisting of the following molecules:

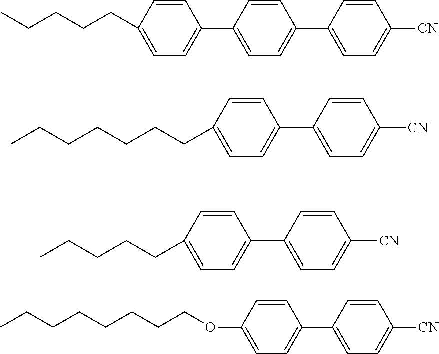

These molecules are present in component 1 in the following fractions from top to bottom: 8%, 25%, 51%, 16% respectively, as is described by A. R. E. Bras et al in J. Chem. Eng. Data 2005, 50, 1857-1860.
2) 15.7 wt % LCP diacrylate

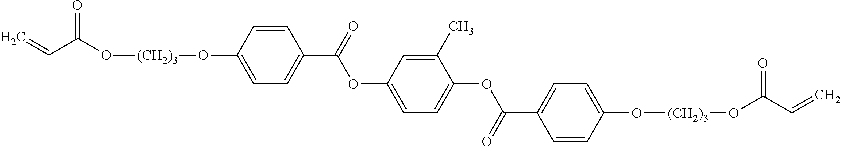

3) 0.2 wt % photo-initiator

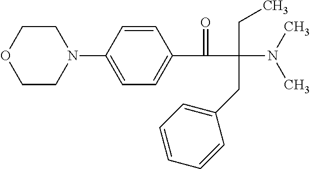 [SMILES: CCC(Cc1ccccc1)(C(=O)c1ccc(N2CCOCC2)cc1)N(C)C]

4) 0.2 wt % planarizing additive

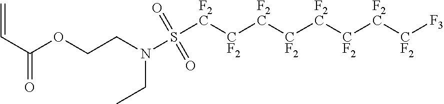

5) 80 wt % solvent para-xylene

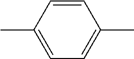

The mixture is then inkjet printed in a pattern consisting of lines and single drops on a polyimide substrate at room temperature. The polyimide substrate was rubbed prior to printing with a velvet cloth so that it exhibits planar alignment on the substrate. The solvent is evaporated during 1 minute at 50° C. on a hot plate during which time the birefringent matrix aligns on the substrate. After this time the mixture is UV polymerized at room temperature under a nitrogen inerted atmosphere during 2 minutes, resulting in a mechanically stable structure.

Direct optical inspection showed that the printed structure is birefringent as well as that the element exhibits polarization selective scattering.

When viewing the element between polarizers oriented 90 degrees relative to each other, it can be seen that the structure is birefringent. When the alignment-axis of the liquid crystal matrix is parallel to either polarizer, the transmission is minimal and the feature is dark. When the feature has the alignment-axis of the liquid crystalline matrix oriented at 45 degrees to both polarizers, transmission is optimal and the feature together with the polarizers is transparent. This clearly indicates that the structure is birefringent.

Using only one polarizer, the polarization scattering effect can be seen. When one polarizer is placed in front of the scatterer, with the polarization axis parallel to the alignment of the liquid crystalline matrix, the element is transmissive. When the polarization axis is orthogonal to the alignment of the liquid crystalline matrix, the element is scattering. This clearly shows that the structure is polarization selectively scattering.

### EXAMPLE 2

A mixture is prepared created by adding components a up to and including h consecutively and stirring it magnetically for 15 minutes at 60° C. until a clear solution is obtained. Then component j is added and the complete mixture is stirred magnetically at 50° C. for 5 minutes, where the components are

a) 15.4 wt % mono-functional LCP acrylate

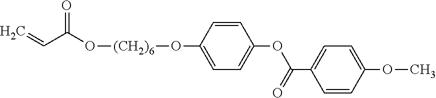

b) 6.6 wt % di-functional LCP acrylate

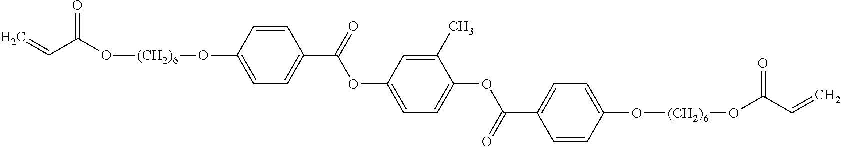

c) 5.6 wt % non-reactive LC monomer K15

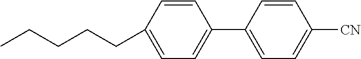 [SMILES: CCCCCc1ccc(-c2ccc(C#N)cc2)cc1]

f) 0.27 wt % photo-initiator

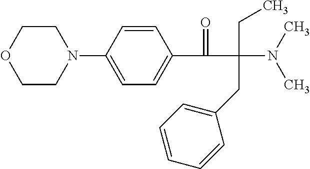 [SMILES: CCC(Cc1ccccc1)(C(=O)c1ccc(N2CCOCC2)cc1)N(C)C]

g) 0.13 wt % inhibitor hydroquinone

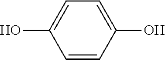

h) 22 wt % solvent para-xylene

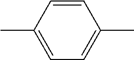

i) 50 wt % of a dispersion of PMMA uniform beads with a mean diameter of 0.11 μm, dispersed in water where a total of 10 wt % of the dispersion consists of the PMMA beads

A layer of 20 um is then applied to a tri-acetyl cellulose film by means of doctor blading at 50° C. The solvent and the water are then allowed to evaporate during 2 minutes, while the substrate and mixture are kept at 50° C., after which the layer is UV polymerized at room temperature under a nitrogen inerted atmosphere for 2 minutes, resulting in a mechanically stable structure.

This structure is visually inspected which shows that the printed structure is birefringent as well as that the element is polarization selective scattering.

When viewing the element between polarizers oriented 90 degrees relative to each other, it can be seen that the structure is birefringent. When the alignment-axis of the liquid crystal matrix is parallel to either polarizer, the transmission is minimal and the feature is dark. When the feature has the alignment-axis of the liquid crystalline matrix oriented at 45 degrees to both polarizers, transmission is optimal and the feature together with the polarizers is transparent. This clearly indicates that the structure is birefringent.

Using only one polarizer, the polarization scattering effect can be seen. When one polarizer is placed in front of the scatterer, with the polarization axis parallel to the alignment of the liquid crystalline matrix, the element is transmissive. When the polarization axis is orthogonal to the alignment of the liquid crystalline matrix, the element is scattering. This clearly shows that the structure is polarization selectively scattering.

The parent application, U.S. Ser. No. 12/530,630 filed Sep. 23, 2009, is incorporated herein by reference in its entirety.

### BRIEF DESCRIPTION OF THE DRAWINGS

FIG. 1: Schematic drawing of a twisted nematic liquid crystal display cell in off (no voltage applied) and on (voltage applied) situation.

FIG. 2: Schematic drawing of a polymer dispersed liquid crystal display cell in a transparent (voltage applied) and scattering (no voltage applied) situation

FIG. 3: Schematic drawing of a cholesteric liquid crystalline layer and the reflection of light by that layer.

FIG. 4: Schematic drawing of a polymer stabilized cholesteric liquid crystal layer in non scattering (voltage off) and scattering (voltage on) situation.

FIG. 5: Schematic drawing of a polarization selective scatterer consisting of a birefringent matrix and a polymer dispersed phase.

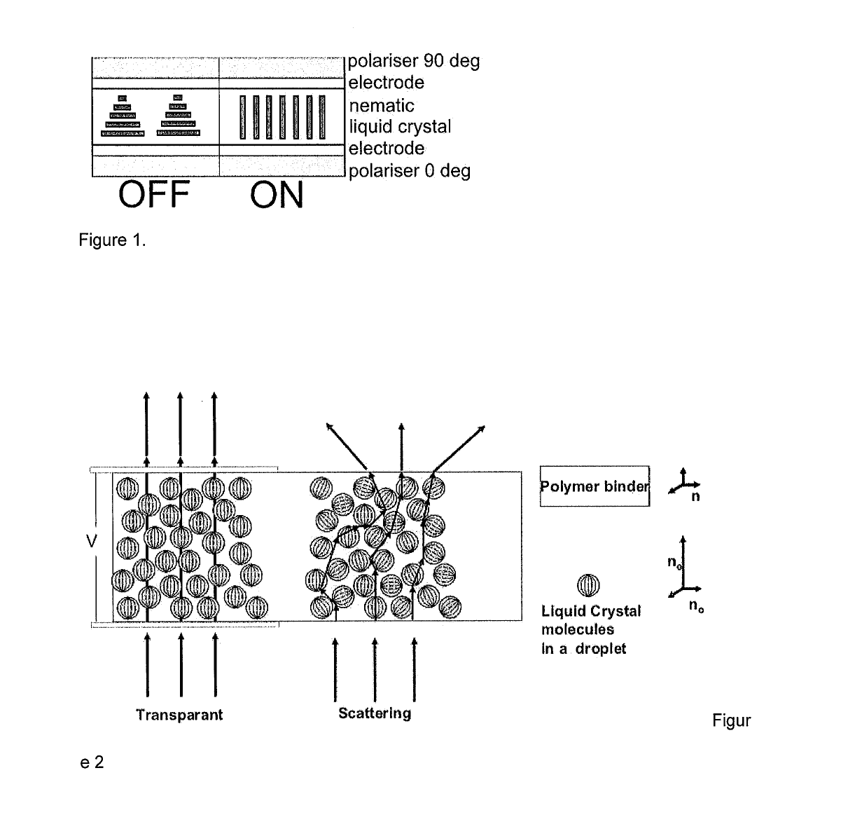

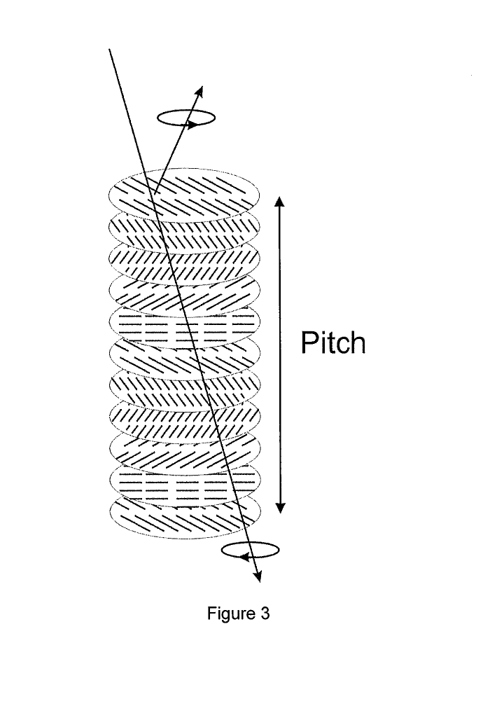

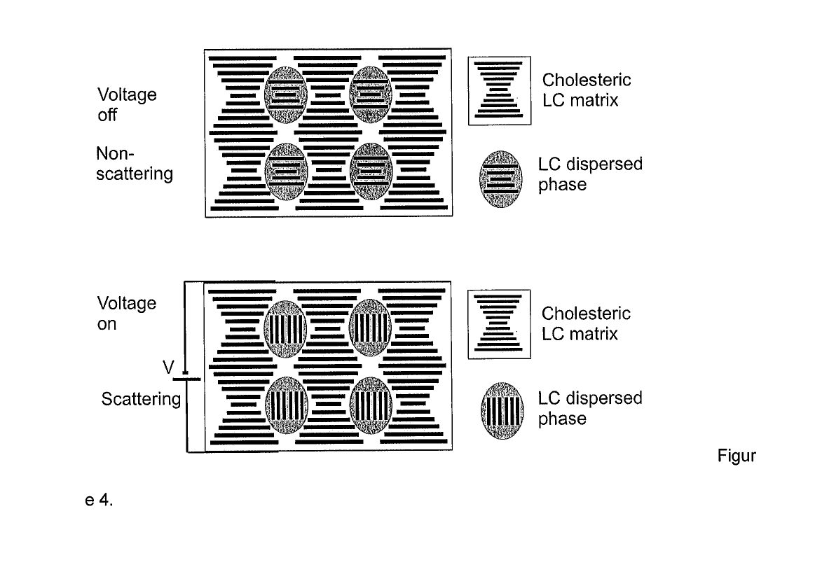

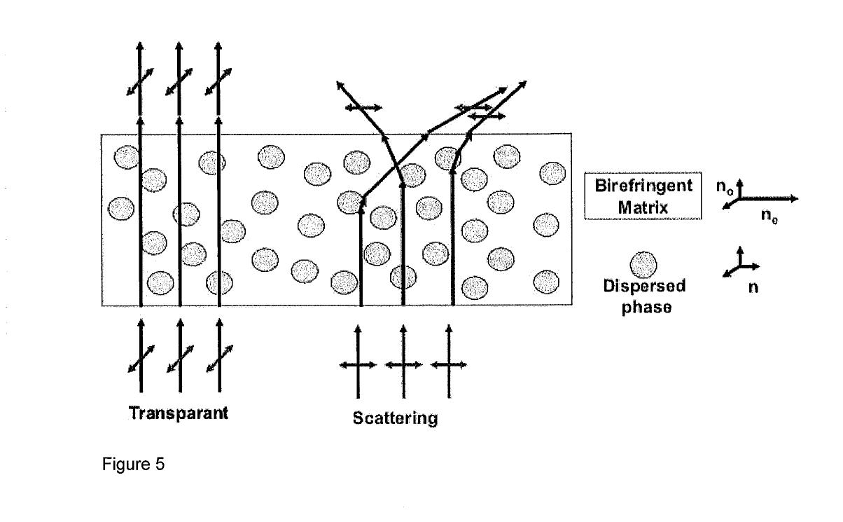

1. A polarization selective scattering security device comprising a printed patterned birefringent matrix of LCP polymer comprising a dispersed phase obtained by means of a phase separation, wherein the ordinary or the extra-ordinary refractive index of the birefringent matrix of LCP polymer is approximately matched by one of the indices of refraction of the dispersed phase whereas the other refractive index is not matched.

2. The polarization selective scattering device of claim 1, wherein the difference Δn_{matching} between the refractive indices of the birefringent matrix of LCP polymer and the dispersed phase that are approximately matched is smaller than 0.05, preferably smaller than 0.01.

3. The polarization selective scattering device according to claim 1, further comprising at least one first additive selected from a group comprising photochromic pigments or dyes, thermochromic pigments or dyes, electrochromic pigments or dyes, ionochromic pigments or dyes, halochromic pigments or dyes, solvatochromic pigments or dyes, trobochromic pigments or dyes and piezochromic pigments or dyes.

4. The polarization selective scattering device according to claim 1, further comprising at least one second additive being a conductive or semi-conductive additive.

5. The polarization selective scattering device according to claim 4 wherein the second additive is selected from a group comprising nanometer or micrometer sized rods, flakes, spheres or otherwise suitably shaped conductive particles of metals, alloys or semiconductor-based materials.

6. The polarization selective scattering device according to claim 4 wherein the second additive is selected from a group comprising
semi-conductive conjugated polymers, and
semi-conductive liquid crystals.

7. The polarization selective scattering device according to claim 1, further comprising a third additive selected from a group comprising magnetic additives.

8. The polarization selective scattering device according to claim 1, wherein the device is aligned by a substrate layer comprising linearly photopolymerizable polymers.

9. The polarization selective scattering device according to 8, wherein the device is aligned by multiple types of alignment through the combination of multiple aligning substrates.

10. The polarization selective scattering device according to claim 8, wherein the substrates contain further authentication features.

11. A process for manufacturing a polarization selective scattering security device according to claim 1, comprising the steps of:
printing a mixture comprising at least one LCP, comprising one or more functional groups as the first material and at least one second material comprising liquid crystalline or non-liquid crystalline molecules and optionally one or more additives
letting the LCP's align on a substrate,
characterized in that
significant fractions of the molecules of the second material are allowed to phase separate from the bulk to form regions with typical sizes in the range of 0.1 to 10 micron and that
during or after phase separation the aligned liquid crystal phase is polymerized to form a solid matrix.

12. The process of claim 11, characterized in that the fraction of the second material is below 50% weight, preferably below 30% weight, more preferably below 15% weight.

13. The process of claim 11, characterized in that the second material is polymerized during the polymerization step.

14. A process for manufacturing a polarization selective scattering security device according to claim 1, comprising the steps of:
printing a mixture comprising at least one LCP, comprising one or more functional groups as the first material and at least one second material comprising pre-polymerised dispersed materials with sizes in the range of 0.1 to 10 micron,
letting the LCP's align on a substrate,
the aligned liquid crystal phase is polymerized to form a solid matrix.

15. The process of claim 14, characterized in that the second material will be distributed within the matrix such that Bragg reflection can occur.

16. The process of claim 11, characterized in that the printing is performed by ink-jet printing.

17. The process of claim 14 wherein the mixture further comprises one or more additives in the first material or the second material or both.
